(19) United States
(12) Patent Application Publication
(10) Pub. No.: US 2024/0262068 A1
(43) Pub. Date: Aug. 8, 2024

(54) SYSTEMS AND METHODS FOR PREPARING EMBOSSED GRAPHITE-BASED WEBS

(71) Applicant: MATTHEWS INTERNATIONAL GmbH, Vreden (DE)

(72) Inventors: Thomas HACKFORT, Ahaus (DE); Frank BOGENSTAHL, Ahaus (DE); Kay WOLTERS, Stadtlohn (DE)

(21) Appl. No.: 18/430,996

(22) Filed: Feb. 2, 2024

Related U.S. Application Data
(60) Provisional application No. 63/442,895, filed on Feb. 2, 2023.

(51) Int. Cl. B30B 3/04; B30B 9/28; H01M 8/0234; H01M 8/0247

(52) U.S. Cl. CPC B30B 3/04; B30B 9/28; H01M 8/0234; H01M 8/0247

(57) ABSTRACT

Systems, methods, and products are described relating to a set of calendering rollers positioned adjacent to a set of embossing rollers or cutting rollers or combination rollers but without a heating unit disposed between them. Produced embossed or cut graphite-based webs having bipolar plate structures can be made with reduced cost and improved quality.

### CROSS-REFERENCE TO RELATED APPLICATIONS

This application claims priority to U.S. Provisional Application No. 63/442,895 filed on Feb. 2, 2023, the entirety of which is incorporated herein by reference.

### BACKGROUND

Bipolar plates are an important component of fuel cells, distributing fuel and air, conducting electrical current, and removing heat produced in the cells' reaction zones. Bipolar plates are also useful in other applications, such as when used as separators in redox-flow batteries.

Embossing and cutting of graphite-based webs traditionally is performed as a separate, discrete process from the multi-roll calendering (MRC) process. The web is cooled after the calendering process, and subsequently heated before embossing and/or cutting.

Despite the commercial success of the two-step process to date, there still exists a need for improved and more efficient methods of preparing embossed and cut graphite-based webs having bipolar plate structures.

### SUMMARY

In some aspects, the techniques described herein relate to a multi-roll method of preparing a processed web having a bipolar plate structure, the method including: providing a multi-roll calender system including one or more calendering rollers and one or more processing rollers, wherein the system does not include any heating units disposed between the calendering rollers and embossing rollers; outputting an unprocessed web from the calendering rollers; and inputting the unprocessed web to the processing rollers to prepare the processed web having a bipolar plate structure; wherein, the one or more processing rollers include one or more cutting rollers, one or more embossing rollers, and/or one or more combination rollers.

In some aspects, the techniques described herein relate to a multi-roll system to prepare a processed web having a bipolar plate structure, the system including: one or more calendering rollers and one or more processing rollers; wherein: the system does not include any heating units disposed between the calendering rollers and processing rollers, and the one or more processing rollers include one or more cutting rollers, one or more embossing rollers, and/or one or more combination rollers.

In some aspects, the techniques described herein relate to a processed graphite-based web having a bipolar plate structure prepared by a multi-roll method, the method including: providing a system including one or more calendering rollers and one or more processing rollers; wherein the system does not include any heating units disposed between the calendering rollers and processing rollers; outputting an unprocessed graphite-based web from the calendering rollers; and inputting the unprocessed graphite-based web to the processing rollers to prepare the processed graphite-based web having a bipolar plate structure; wherein, the one or more processing rollers include one or more cutting rollers, one or more embossing rollers, and/or one or more combination rollers.

### BRIEF DESCRIPTION OF THE DRAWINGS

Aspects, features, benefits, and advantages of the embodiments described herein will be apparent with regard to the following description, appended claims, and accompanying drawings where:

FIG. 1 shows a system containing seven calendering rollers 100 and two embossing rollers 200, with no heating unit 300 positioned between. The arrows and dark curved arc show the material path through the system rollers.

FIG. 2 shows a system having different zones. In sequence, the system has a melting zone 400, a kneading zone 500, a cooling/tempering zone 600, and an embossing zone 700.

FIG. 3 shows a system having a heating unit 300 positioned between calendering rollers 100 and embossing rollers 200.

### DETAILED DESCRIPTION

This disclosure is not limited to the particular systems, devices and methods described, as these may vary. The terminology used in the description is for the purpose of describing the particular versions or embodiments only, and is not intended to limit the scope.

A “calendering roller” refers to a roller which applies one or more of heat, pressure, shear, or other physical condition to the web of graphite film. A system may have one or more calendering rollers or two or more calendering rollers. Calendering rollers are typically configured in pairs, and gauge a material to a predetermined thickness or density by passing the material through a controlled gap.

A “heating unit” refers to a device which increases the temperature of the unprocessed web before it contacts the processing rollers.

### Systems

In one example of the technology, systems are described that can be used to prepare processed webs having bipolar plate structures. In some examples, the processed webs having bipolar plate structures are processed graphite-based webs having bipolar plate structures made from graphite webs/films. In some embodiments, the processed webs comprise one or more embossed bipolar plate structures. In one embodiment, the processed webs comprise one or more cut bipolar plate structures. The systems may comprise one or more calendering rollers and one or more processing rollers. The system does not comprise any heating units disposed between the calendering rollers and the processing rollers. In some embodiments, the one or more processing rollers are positioned adjacent to the one or more calendering rollers. The system is configured such that an output of the calendering rollers (an unprocessed web) becomes the input of the processing rollers without being exposed to or contacting a heating unit after the calendering rollers but before the processing rollers. The system is not configured to heat the output of the calendering rollers before it becomes the input of the processing rollers. The output of the processing rollers is a processed web having at least one bipolar plate structure. In some embodiments, the one or more processing rollers comprise one or more embossing rollers. In some embodiments, the one or more processing rollers comprise one or more cutting rollers. In still further embodiments, the processing rollers comprise one or more rollers that during operation both cut and emboss the web as roller contacts the web. Such rollers that both cut and emboss the webs are referred to as combination rollers.

In some embodiments, the one or more embossing rollers comprise at least one embossing roller with male embossing features and at least one embossing roller with female embossing features. In some embodiments, the male embossing features and the female embossing features are configured to align as a web passes between the embossing rollers.

The system may be configured such that the temperature of the output of the calendering rollers is higher than or equal to the temperature of the input of the processing rollers. The system may be configured such that the temperature of the output of the calendering rollers does not drop below the temperature of the input of the processing rollers. In some examples, the system is configured such that the output of the calendering rollers directly proceeds to be the input of the processing rollers without any additional processing.

The number of calendering rollers and processing rollers may generally be any number. The number of calendering rollers and processing rollers may generally be any positive non-zero integer. The number of calendering rollers and processing rollers may be the same or different. For example, the number of calendering rollers may be 2 or more, such as 2, 3, 4, 5, 6, 7, 8, or more calendering rollers. For example, the number of processing rollers may be 2 or more, such as 2, 3, 4, 5, 6, 7, 8, or more processing rollers. In some specific examples, the number of processing rollers may be 2 (a pair of processing rollers).

In some embodiments, the one or more processing rollers comprise one or more embossing rollers. The number of embossing rollers may generally be any number. The number of embossing rollers may generally be any positive non-zero integer. The number of embossing rollers may be the same or different than the number of calendering rollers. For example, the number of embossing rollers may be 2 or more, such as 2, 3, 4, 5, 6, 7, 8, or more embossing rollers. In some specific examples, the number of embossing rollers may be 2 (a pair of embossing rollers).

In some embodiments, the one or more processing rollers comprise one or more cutting rollers. The number of cutting rollers may generally be any number. The number of cutting rollers may generally be any positive non-zero integer. The number of cutting rollers may be the same or different than the number of calendering rollers. For example, the number of cutting rollers may be 2 or more, such as 2, 3, 4, 5, 6, 7, 8, or more cutting rollers. In some specific examples, the number of cutting rollers may be 2 (a pair of cutting rollers).

In some embodiments, the one or more processing rollers comprise one or more combination rollers. The number of combination rollers may generally be any number. The number of combination rollers may generally be any positive non-zero integer. The number of combination rollers may be the same or different than the number of calendering rollers. For example, the number of combination rollers may be 2 or more, such as 2, 3, 4, 5, 6, 7, 8, or more combination rollers. In some specific examples, the number of combination rollers may be 2 (a pair of combination rollers).

In some embodiments, the one or more cutting rollers or combination rollers comprise at least one cutting roller or combination roller with male cutting features and at least one cutting roller or combination roller with female cutting features. In some embodiments, the male cutting features and the female cutting features are configured to align as a web passes between the cutting rollers or combination rollers.

In some embodiments, the one or more processing rollers comprise one or more cutting rollers and one or more embossing rollers. In some embodiments, the one or more cutting rollers are positioned before the one or more embossing rollers. In some embodiments, the system is configured so the output of the one or more cutting rollers is the input of the one or more embossing rollers. In some embodiments, the one or more embossing rollers are positioned before the one or more cutting rollers. In some embodiments, the system is configured so the output of the one or more embossing rollers is the input of the one or more cutting rollers. Similarly, one or more combination rollers can be provided before, between, or subsequent to the cutting rollers or embossing rollers so that the output of one roller or group of rollers can be inputted to the next roller or group of rollers.

The calendering rollers may be organized into one or more sets or zones. For example, there may be a melting zone, a kneading zone, and a cooling/tempering zone. In a specific example, two calendering rollers may be in a melting zone, four calendering rollers in a kneading zone, and one calendering roller in a cooling/tempering zone. The various zones may be configured adjacent to each other such that material is constantly in contact with at least one roller during the methods.

### Methods of Preparing

In another example of the technology, methods are described to prepare processed webs having bipolar plate structures such as processed graphite-based webs having bipolar plate structures. The methods may comprise providing a system comprising one or more calendering rollers and one or more processing rollers; wherein the system does not comprise any heating units disposed between the calendering rollers and processing rollers; outputting an unprocessed web from the calendering rollers; and inputting the unprocessed web to the processing rollers to prepare the processed web having at least one bipolar plate structure. In some embodiments, the one or more processing rollers are positioned adjacent to the one or more calendering rollers. In some embodiments, the one or more processing rollers comprise one or more embossing rollers. In some embodiments, the one or more processing rollers comprise one or more cutting rollers. In some embodiments, the at least one bipolar structure comprises at least one embossed bipolar structure. In some embodiments, the at least one bipolar structure comprises at least one cut bipolar structure.

In some embodiments, the one or more embossing rollers comprise at least one embossing roller with male embossing features and at least one embossing roller with female embossing features. In some embodiments, the method further comprises aligning the male embossing features and the female embossing features. In some embodiments, the male embossing features and the female embossing features are aligned as the unprocessed web is input between the embossing rollers. In some embodiments, the one or more embossing rollers are configured to output an embossed web having at least one embossed bipolar plate structure.

In some embodiments, the system further comprises one or more cutting rollers, and the method further comprises inputting the embossed web to the cutting rollers to prepare a cut web. In some embodiments, the system further comprises one or more cutting rollers, and the method further comprises inputting the unprocessed web to the cutting rollers to prepare a cut web. In some embodiments, the one or more embossing rollers are configured to output a cut web having at least one cut bipolar plate structure. Similarly, one or more combination rollers can be provided before, between, or subsequent to the cutting rollers or embossing rollers so that the output of one roller or group of rollers can be inputted to the next roller or group of rollers.

In some embodiments, the one or more cutting rollers comprise at least one cutting roller or combination roller with male cutting features and at least one cutting roller or combination roller with female cutting features. In some embodiments, the method further comprises aligning the male cutting features and the female cutting features. In some embodiments, the male cutting features and the female cutting features are aligned as the unprocessed web is input between the cutting rollers. In some embodiments, the method further comprises aligning the male cutting features and the female cutting features as an embossed web is input between the cutting rollers or combination rollers.

In some examples, a temperature of the unprocessed web when output from the calendering rollers is substantially the same as a temperature of the unprocessed web when input to the processing rollers. In other examples, the methods may further comprise cooling the unprocessed web after it is output from the calendering rollers and before it is input into the processing rollers. For example, the unprocessed web may be cooled to a desired input temperature for the processing rollers. In some embodiments, the processed web may be cooled after processing. In some embodiments, the processed web may be cooled after embossing. In some embodiments, the processed web may be cooled after cutting.

The methods may reduce energy usage, capital expenditure, and operational expenditure relative to a system having at least one heating unit between the calendering rollers and the processing rollers. Additionally, there is no need to wind and unwind the unprocessed material before processing. The method may reduce energy consumption as compared to a system without the multi-rolling arrangement, as the repeated heating of the material between the rolling steps in the multi-rolling arrangement is not necessary.

The produced processed web having at least one bipolar plate structure may be subjected to further processing such as applying adhesive, winding, cutting, and so on.

The methods may further comprise one or more additional upstream steps, such as, for example, contacting raw material between the first and second rollers. The raw material may be in various physical forms such as powder or flakes. In some examples, the raw material is graphite powder or graphite flakes. The method may further comprise melting the raw material. The method may further comprise kneading the melted raw material to create a homogeneous web. The method may further comprise lowering the homogeneous web to a temperature suitable for embossing. In some examples, the web is supported by at least one roller during the entire preparation method from formation of the initial homogeneous web through processing. In these examples, no web handling is required between the various preparation steps.

### Products

In other examples of the technology, processed graphite-based webs having at least one bipolar plate structure prepared by one or more of the above-described methods are described. In some embodiments, the processed graphite-based web comprises at least one embossed bipolar plate structure. In some embodiments, the processed graphite-based web comprises at least one cut bipolar plate structure. The products produced by the described methods are expected to have superior quality and consistency relative to conventional embossed webs. For example, the products are expected to have fewer defects per unit area and lower stress values.

Clause 1. A multi-roll method of preparing an embossed web having a bipolar plate structure, the method comprising: providing a system comprising one or more calendering rollers and one or more embossing rollers; wherein the system does not comprise any heating units disposed between the calendering rollers and embossing rollers; outputting an unembossed web from the calendering rollers; and inputting the unembossed web to the embossing rollers to prepare the embossed web having a bipolar plate structure.

Clause 2. The method of clause 1, not comprising heating the unembossed web after it is output from the calendering rollers and before it is input into the embossing rollers.

Clause 3. The method of clause 1, further comprising cooling the unembossed web after it is output from the calendering rollers and before it is input into the embossing rollers.

Clause 4. The method of clause 1, wherein the unembossed web is an unembossed graphite-based web.

Clause 5. The method of clause 1, wherein the embossed web is an embossed graphite-based web.

Clause 6. A multi-roll system to prepare an embossed web having a bipolar plate structure, the system comprising: one or more calendering rollers and one or more embossing rollers; wherein: the system does not comprise any heating units disposed between the calendering rollers and embossing rollers.

Clause 7. The system of clause 6, configured such that an output of the calendering rollers becomes an input of the embossing rollers.

Clause 8. The system of clause 6, configured such that an output of the calendering rollers is an unembossed web.

Clause 9. The system of clause 6, configured such that an output of the calendering rollers is an unembossed graphite-based web.

Clause 10. The system of clause 6, configured such that an output of the embossing rollers is an embossed web having a bipolar plate structure.

Clause 11. The system of clause 6, configured such that an output of the embossing rollers is an embossed graphite-based web having a bipolar plate structure.

Clause 12. The system of clause 6, comprising 2 or more calendering rollers.

Clause 13. The system of clause 6, comprising 7 calendering rollers.

Clause 14. The system of clause 6, comprising 2, 3, 4, 5, 6, 7, or 8 calendering rollers.

Clause 15. The system of clause 6, comprising 2 or more embossing rollers.

Clause 16. The system of clause 6, comprising 2 embossing rollers.

Clause 17. The system of clause 6, comprising 2, 3, 4, 5, 6, 7, or 8 embossing rollers.

Clause 17. The system of clause 6, wherein the embossed web having a bipolar plate structure is an embossed graphite-based web having a bipolar plate structure.

Clause 18. An embossed graphite-based web having a bipolar plate structure prepared by a multi-roll method, the method comprising: providing a system comprising one or more calendering rollers and one or more embossing rollers; wherein the system does not comprise any heating units disposed between the calendering rollers and embossing rollers; outputting an unembossed graphite-based web from the calendering rollers; and inputting the unembossed graphite-based web to the embossing rollers to prepare the embossed graphite-based web having a bipolar plate structure.

### EXAMPLES

### Example 1: Assembly of a System Without Heating

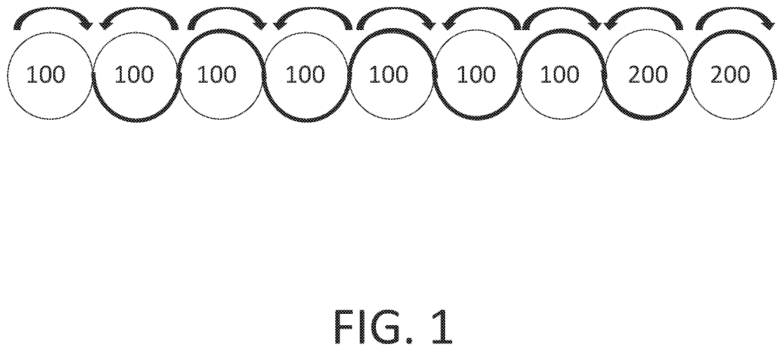

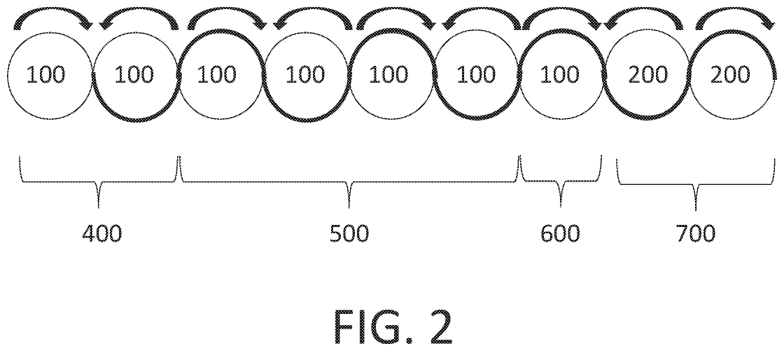

This Example is shown in FIGS. 1 and 2. A set of seven calendering rollers 100 and two processing rollers 200 can be assembled. The rollers can be configured as two calendering rollers in a melting zone 400, four calendering rollers in a kneading zone 500, and one calendering roller in a cooling/tempering zone 600.

A pair of processing rollers 200 can be configured directly adjacent to the final seventh calendering roller with no heating unit 300 between them (not shown). The processing rollers 200 may comprise one or more embossing rollers and/or one or more cutting rollers.

### Example 2: Assembly of a System with Heating

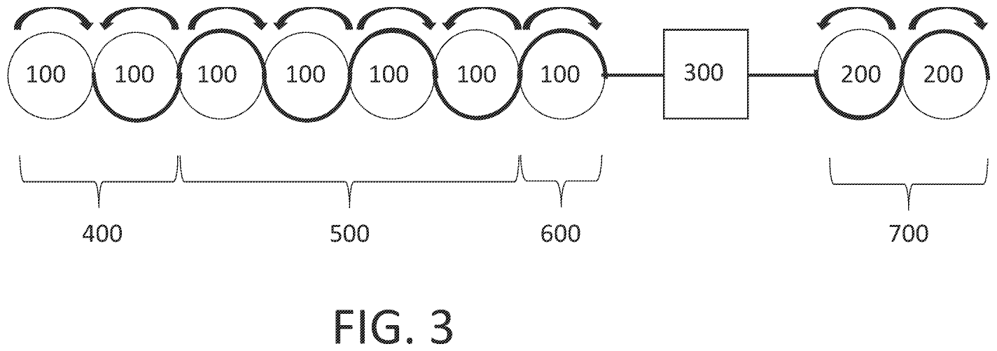

This Example is shown in FIG. 3. A set of seven calendering rollers 100 can be assembled. The calendering rollers can be configured as two calendering rollers in a melting zone 400, four calendering rollers in a kneading zone 500, and one calendering roller in a cooling/tempering zone 600.

A pair of processing rollers 200 can be configured separately from the final seventh calendering roller. A heating unit 300 can be positioned before the processing rollers 200. The processing rollers 200 may comprise one or more embossing rollers and/or one or more cutting rollers.

### Example 3: Use of a System Without Heating Unit

This Example describes use of the system of Example 1. The set of calendering rollers can be used to produce an unprocessed graphite-based web. The web will pass directly from the calendering rollers into a pair of processing rollers to produce processed graphite-based webs having at least one bipolar plate structure. The processed webs will be cooled and subjected to further processing as desired.

### Example 4: Use of a System with Heating Unit

This Example describes use of the system of Example 2. The set of calendering rollers can be used to produce unprocessed graphite-based webs. The webs will be wound, cooled, and moved to a separate set of processing rollers.

The unprocessed webs will be heated using a heating unit to reach the appropriate desired processing temperature before passing into the processing rollers to produce processed graphite-based webs having at least one bipolar plate structure. The processed webs will be cooled and subjected to further processing as desired.

### Example 5: Comparison of Systems with and Without Heating

The system of Example 1 is expected to operate with improved efficiency, consistency, and energy usage relative to the system of Example 2. In particular, omitting a heating unit between the calendering rollers and the processing rollers is expected to significantly reduce energy usage and capital expenditure (capex)/operational expenditure (opex). Additionally, a simpler system is expected to have fewer unplanned downtimes due to less frequent breakage and unplanned maintenance needs.

### Example 6: Comparison of Produced Processed Products

The finished processed graphite-based webs having at least one bipolar plate structure produced from Examples 3 and 4 can be compared. It is expected that the processed webs produced from the direct system lacking a heating unit (described in Examples 1 and 3) will be superior in quality to those produced from the indirect system having a heating unit (described in Examples 2 and 4).

### Example 7: Preparation of Processed Web From Graphite Flakes or Powder

The system of FIG. 1 will be used. Graphite powder or flakes will be loaded between the first two calendering rollers where they will be melted in the melting zone. It will next pass into a kneading zone then a cooling/tempering zone, resulting in an unprocessed web. The unprocessed web will directly pass into processing rollers to form a processed graphite-based web having a bipolar plate structure. The web does not leave contact with one or more rollers until it has been processed.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, materials, compositions, or systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A multi-roll method of preparing a processed web having a bipolar plate structure, the method comprising:
providing a multi-roll calender system comprising one or more calendering rollers and one or more processing rollers, wherein the system does not comprise any heating units disposed between the calendering rollers and embossing rollers;
outputting an unprocessed web from the calendering rollers; and
inputting the unprocessed web to the processing rollers to prepare the processed web having a bipolar plate structure;
wherein, the one or more processing rollers comprise one or more cutting rollers, one or more embossing rollers, and/or one or more combination rollers.

2. The method of claim 1, wherein a temperature of the unprocessed web when output from the calendering rollers is substantially the same as a temperature of the unprocessed web when input to the processing rollers.

3. The method of claim 1, further comprising cooling the unprocessed web after it is output from the calendering rollers and before it is input into the processing rollers.

4. The method of claim 1, wherein the unprocessed web is an unprocessed graphite-based web.

5. The method of claim 1, wherein the processed web is a processed graphite-based web.

6. The method of claim 1, wherein the processing rollers comprise at least one embossing roller or combination roller comprising male embossing features and at least one embossing roller or combination roller comprising female embossing features, the method further comprising:
aligning the male embossing features and the female embossing features.

7. The method of claim 1, wherein the processing rollers comprise at least one cutting roller or combination roller comprising male cutting features and at least one cutting roller or combination roller comprising female cutting features, the method further comprising:
aligning the male cutting features and the female cutting features.

8. The method of claim 1, wherein the processing rollers are positioned adjacent to the calendering rollers.

9. A multi-roll system to prepare a processed web having a bipolar plate structure, the system comprising:
one or more calendering rollers and one or more processing rollers; wherein:
the system does not comprise any heating units disposed between the calendering rollers and processing rollers, and
the one or more processing rollers comprise one or more cutting rollers, one or more embossing rollers, and/or one or more combination rollers.

10. The system of claim 9, configured such that an output of the calendering rollers becomes an input of the processing rollers.

11. The system of claim 9, configured such that an output of the calendering rollers is an unprocessed web.

12. The system of claim 9, configured such that an output of the calendering rollers is an unprocessed graphite-based web.

13. The system of claim 9, configured such that an output of the processing rollers is a processed web having a bipolar plate structure.

14. The system of claim 9, configured such that an output of the processing rollers is a processed graphite-based web having a bipolar plate structure.

15. The system of claim 9, comprising 2 or more calendering rollers.

16. The system of claim 9, comprising 7 calendering rollers.

17. The system of claim 9, comprising 2, 3, 4, 5, 6, 7, or 8 calendering rollers.

18. The system of claim 9, comprising 2 or more processing rollers.

19. The system of claim 9, comprising 2 processing rollers.

20. The system of claim 9, comprising 2, 3, 4, 5, 6, 7, or 8 processing rollers.

21. The system of claim 9, wherein the processed web having a bipolar plate structure is an processed graphite-based web having a bipolar plate structure.

22. A processed graphite-based web having a bipolar plate structure prepared by a multi-roll method, the method comprising:
providing a system comprising one or more calendering rollers and one or more processing rollers; wherein the system does not comprise any heating units disposed between the calendering rollers and processing rollers;
outputting an unprocessed graphite-based web from the calendering rollers; and
inputting the unprocessed graphite-based web to the processing rollers to prepare the processed graphite-based web having a bipolar plate structure;
wherein, the one or more processing rollers comprise one or more cutting rollers, one or more embossing rollers, and/or one or more combination rollers.
